(19) United States
(12) Patent Application Publication
(10) Pub. No.: US 2020/0096670 A1
(43) Pub. Date: Mar. 26, 2020

(54) ANTIFOULING COATING FOR MARINE STREAMERS AND A METHOD FOR ITS USE

(71) Applicants: Erik GODØY, Nesbru (NO); POLARCUS DMCC, Dubai (AE)

(72) Inventor: Ville Petteri IKONEN, DUBAI (AE)

(73) Assignees: POLARCUS DMCC, Dubai (AE); Erik GODØY

(21) Appl. No.: 16/484,484

(22) PCT Filed: Mar. 21, 2018
(86) PCT No.: PCT/NO2018/050083

§ 371 Date: Aug. 8, 2019

(30) Foreign Application Priority Data
Mar. 30, 2017 (NO) 20170529

(51) Int. Cl. G01V 13/00; G01V 1/20; C09D 5/16; G01V 1/38

(52) U.S. Cl. CPC G01V 13/00; G01V 1/38; C09D 5/1693; G01V 1/201

(57) ABSTRACT

A coating (100) for a marine seismic streamer with several streamer sections (110, 130) connected by connectors (120), wherein the coating (100) is a sheet comprising a substrate (101) for containing an antifouling agent. The coating (100) is cut into a strip, e.g. a tape (104) with an adhesive layer, which may be wrapped around a streamer connector (120), where barnacles and other marine organisms thrive.

### FIELD OF THE INVENTION

The present invention concerns an antifouling coating for marine streamers and a method for its use.

### PRIOR AND RELATED ART

In a marine seismic survey, a survey vessel tows an array of streamers a few metres below the sea surface at about 5 knots or less (˜2.5 m/s) for several weeks or months. These conditions permit barnacles and other marine species to grow on the streamers. Such growth on marine manmade structures is called ‘fouling’, and has been a problem long before seismic streamers were conceived. For example, copper oxides have been used for centuries in marine paints to prevent barnacles from growing on hulls. Copper oxide is toxic for barnacles, and an example of early biocides. Copper oxides are also examples of non-degradable substances that build up in a food chain, potentially to levels where it becomes a health hazard for marine life and/or humans.

Fouling on seismic streamers increases the hydrodynamic drag substantially, as a typical towed array comprises several streamers, each several kilometres long. In addition, fouling may degrade the seismic measurements because an uneven surface causes flow noise. A third problem is to remove fouling during retrieval to prevent that algae, bacteria, barnacles etc. rot while the streamers are stored on reels between surveys. Less fouling means less cleaning and less pollution from detergents. Thus, there is a need for an environmentally friendly antifouling coating for marine streamers.

Several thousand species including bacteria, algae and invertebrates contribute to fouling. Some antifouling paints and coatings contain biocides targeting a broad spectrum of these species, and biocide concentrations are adapted to the most resilient species. This increases the amount of biocides released to the environment Like the metal oxides discussed above, some of the synthetic biocides degrade slowly and may build up in a food chain and thereby harm marine life and/or humans unintentionally. Hence, regulations such as the EU Biocide Product Directive controls the use of biocides.

Strategies to meet regulations includes targeting a smaller number of species and provide degradable biocides in carefully adapted doses. Moreover, antifouling agents are not necessarily toxic. For example, according to Wikipedia, medetomidine is a synthetic drug used as a surgical anaesthetic in veterinary medicine and as an antifouling agent in marine paints. Medetomidine interacts with receptors in the legs of barnacle larvae and causes the larvae to swim away rather than settling. They do not eat or remove the active substance. The drug has similar effects on other hard fouling such as tubeworms. Swedish company I-Tech AB sell medetomidine for use in marine paints under the name Selektope.

Painting streamers is challenging. Specifically, each streamer typically comprises several sections, each several hundred metres long. Various connectors connect the streamer sections. Painting an entire streamer or streamer section during manufacture is impractical because the paint must dry on at least several hundred metres of cable before putting a streamer section onto a reel. In addition, painting the connectors makes it more difficult to detach streamer sections for repair or maintenance. Painting during deployment would require a paint that dry exceptionally fast.

EP 2 700 981 A1 discloses an antifouling removable streamer second skin which is applied to the entire streamer during deployment. During retrieval, the second skin is removed and discarded. This limits the need for cleaning by brushes etc. A potential drawback of this method is the amount of manpower and/or automatic devices needed to apply and remove the second skin to/from kilometres of streamers.

U.S. Pat. No. 9,016,227B2 discloses a net that is applied to at least one streamer section during deployment. The cords of the net carry an antifouling agent. This method has some or all the potential drawbacks of the previous method, notably the effort to apply and remove the net.

U.S. Pat. No. 9,428,651B2 discloses a fouling and stiction-resistant coating suitable for use with marine streamers. The coating is made from a silicone undercoat layer and a powdery topcoat layer. The powdery topcoat layer is preferably a non-toxic fluoropolymer which has a low surface energy, a high modulus, and which is not continuous. There may also be a primer layer below the silicone undercoat layer. The powdery topcoat layer is preferably arranged to be penetrable by the feet of barnacles that come into contact with it, with the silicone undercoat layer arranged such that the barnacles' feet that penetrate the powdery topcoat layer bond with the silicone undercoat layer. The powdery topcoat layer is preferably further arranged to peel away from the silicone undercoat layer when force is applied to the barnacles to remove them from the coating.

A main objective of the present invention is to provide an improved antifouling coating while retaining benefits from prior art.

### SUMMARY OF THE INVENTION

This is achieved with an antifouling coating according to claim 1 and a method according to claim 6. Further features and benefits appear in the dependent claims.

In a first aspect, the invention concerns a coating for a marine seismic streamer with several streamer sections connected by connectors, wherein the coating is a sheet comprising a substrate for containing an antifouling agent. The coating is cut into a strip with a width less than 1.2 times the length of longest streamer connector in the marine seismic streamer.

The strip is easy to handle during deployment compared to long nets or large sheets, and it is wide enough to cover any connector and parts of the streamer sections on either side of the connector. During retrieval, the coating can be cut and peeled off the streamer.

Some embodiments comprise an adhesive layer. The adhesive layer stick to part of the streamer and/or to an underlying substrate.

Some embodiments with an adhesive layer comprise a protective layer covering the adhesive layer during storage and transport. The protective layer is peeled off before the substrate is attached to the streamer or a part thereof.

In some embodiments, the substrate and adhesive layer form an adhesive tape, i.e. a strip with a width substantially less than the length of a connector. Such a tape can be wound several times around the connector in order to cover the entire length of the connector.

As an alternative to tape, the substrate can be wider than the length of the streamer connector and longer than the circumference of the streamer connector. When wrapped around the connector, the strip covers the metal underneath. Varieties with or without an adhesive layer are easily applied and removed.

In a second aspect, the invention concerns a method for applying the coating above, comprising the steps of:
a) winding the strip around parts of the streamer;
b) deploying the streamer to the sea; and
c) retrieving the streamer from the sea.

For example, the coating may be wrapped around a connector and attached by clamps to streamer sections on either side. The steps of b) deploying and c) retrieving the streamers are mandatory and follow step a) in alphabetical order.

Step a) winding may further comprise limiting the winding to a part near a streamer connector. Connectors are places where barnacles thrive. Fouling is a lesser problem along the slick streamer sections.

The method may further comprise the step of storing the streamer on a reel before step b) deploying. The method may be repeated. Thus, step a) wrapping may be performed as the streamer is rolled onto a reel during first-time assembly or later during retrieval from the sea. The step of storing the streamer on a reel is optional because step a) wrapping may be performed during deployment of the streamer to the sea and because there are conceivable alternatives to reels for storing a streamer on the deck of a survey vessel.

Coating wound around connectors is easily removed by engaging the connector with a cutting edge during retrieval. Such a cutting edge does not harm metallic connectors, but may damage the soft skin on a streamer section.

Regardless of which parts of the streamers that were covered by the coating, step c) retrieving the streamer may comprise cleaning the streamer with mechanical and/or chemical means. Known procedures typically involve brushes, water-jets and detergents to remove residual fouling before storage.

### BRIEF DESCRIPTION OF THE DRAWINGS

The invention will be explained with reference to exemplary embodiments and the accompanying drawings, in which:

FIG. 1 illustrates a coating according to the invention,

FIG. 2 shows the coating applied as an adhesive tape to a connector,

FIG. 3 shows the coating in the form of a sheet covering a connector and

FIG. 4 illustrates a method according to the invention.

### DETAILED DESCRIPTION OF A PREFERRED EMBODIMENT

The drawings are schematic and not necessarily to scale. Numerous details known to the skilled person are omitted from the drawings and following description.

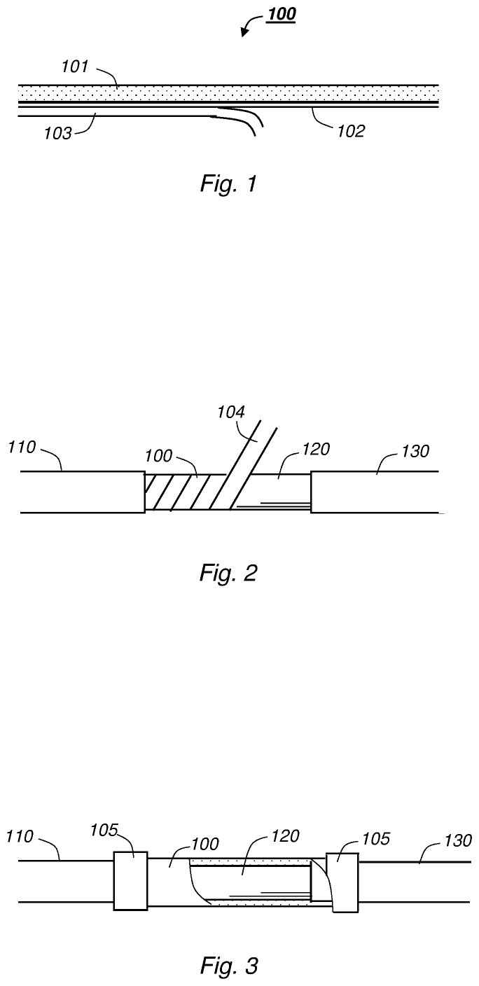

FIG. 1 illustrates an antifouling coating 100 comprising a substrate 101 and an adhesive layer 102. The substrate 101 is any material capable of carrying a suitable antifouling agent, e.g. a fibrous material in a net, a woven or nonwoven textile, paper or a layer of plastic such as PVC.

Currently preferred embodiments comprise the adhesive layer 102. However, this layer is optional. Embodiments with an adhesive layer 102 may be provided with an optional cover sheet 103 during manufacture. Otherwise, the coating will stick to itself, e.g. when rolled up. Whether the adhesive layer should be provided with a cover sheet 103 is a design issue. Band-aid with a cover sheet and electric insulation tape without a cover sheet are everyday examples indicating that both varieties work well.

FIG. 2 shows the coating 100 applied as an adhesive tape 104 over a connector 120, which connects streamer sections 110 and 130. This embodiment facilitates swift application and removal, e.g. by a relatively simple rotating dispenser during deployment and a cutting edge engaging the connector during retrieval. The coating 100 does not cover the streamer sections 110, 130, which are conveniently cleaned by brushes, water jets, a detergent and/or similar means before storage.

FIG. 3 shows the coating 100 applied as a sheet wrapped around the connector 120. Clamps 105 at the ends attach the sheet to streamer sections 110 and 130, respectively. Shrink-wrapping, i.e. applying heat to the sheet causing it to retract, is considered an obvious alternative to the clamps 105.

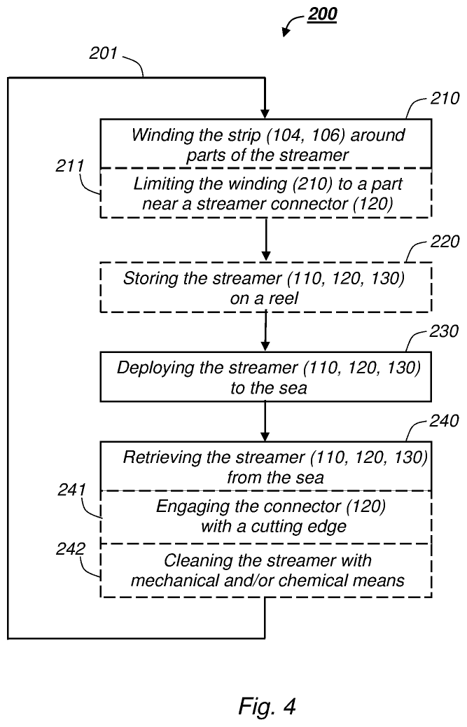

FIG. 4 illustrates a method 200 for using the coating 100. Loop 201 indicates repetition of the method 200.

In the first step 210 of loop 201, the strip 104, 106 of coating is wound around parts of the streamer 110, 120, 130, e.g. a connector 120 and short parts of the streamer segments 110 and 130 on either side as illustrated in FIG. 3 and indicated by optional step 211.

Step 220, storing the streamer on a reel is optional. For example, a streamer may be provided with a strip 104, 106 in step 210 and possibly step 211 during manufacturing. The streamer may then be brought to a survey vessel on reels. During the first retrieval, a new coating may replace the first and fouled coating, and a wrapped coating may be stored on the original storage reels. Alternatively, a wrapped or unwrapped streamer may be stored temporarily on deck without using storage reels, e.g. for maintenance or repair.

Step 230 involves deploying the streamer to the sea. FIG. 4 does not indicate time, so step 210 wrapping may be performed shortly before or ‘during’ deployment.

Mandatory step 240 comprises retrieving the streamer 110, 120, 130 from the sea.

Optional step 241, engaging the connector 120 with a cutting edge, is performed ‘during’ retrieval or shortly afterwards. The purpose is to shear the coating at the connectors 120 to facilitate removal of the fouled coating. The cutting edge is applied at the metallic connectors 120 to avoid damage to the soft surface of the streamers. Cutting at the connectors 120 does not imply that the coating 100 is limited as in step 211. Indeed, removing strips 104, 106 wrapped around entire streamer sections 110, 130 may be facilitated by a cut at a connector 120.

Optional step 242 involves conventional cleaning with brushes, water-jets, detergents etc. The purpose is to remove residual fouling, e.g. from streamer sections 110, 130 in embodiments where only sections at connectors 120 are covered by the coating 100.

While the invention is described by way of examples, the scope of the invention is defined by the accompanying claims.

1-10. (canceled)

11. A coating for a marine seismic streamer with several streamer sections connected by connectors, wherein the coating is a sheet comprising a substrate for containing an antifouling agent, wherein the coating is cut into a strip with a width less than 1.2 times the length of longest streamer connector in the marine seismic streamer.

12. The coating according to claim 11, further comprising an adhesive layer.

13. The coating according to claim 12, further comprising a protective layer for covering the adhesive layer during storage and transport.

14. The coating according to claim 13, wherein the substrate and adhesive layer form an adhesive tape.

15. The coating according to claim 14, wherein the substrate and adhesive layer form an adhesive tape.

16. The coating according to claim 11, wherein the substrate is wider than the length of the streamer connector and longer than the circumference of the streamer connector.

17. A method for applying the coating according to claim 11, comprising the steps of:
a) winding the strip around parts of the streamer;
b) deploying the streamer to the sea; and
c) retrieving the streamer from the sea.

18. The method according to claim 17, wherein step a) winding further comprises limiting the winding to a part near a streamer connector.

19. The method according to claim 17, further comprising the step of storing the streamer on a reel before step b) deploying.

20. The method according to claim 18, further comprising the step of storing the streamer on a reel before step b) deploying.

21. The method according to claim 17, wherein step c) retrieving the streamer comprises engaging the connector with a cutting edge.

22. The method according to claim 18, wherein step c) retrieving the streamer comprises engaging the connector with a cutting edge.

23. The method according to claim 19, wherein step c) retrieving the streamer comprises engaging the connector with a cutting edge.

24. The method according to claim 17, wherein step c) retrieving the streamer comprises cleaning the streamer with mechanical and/or chemical means.

25. The method according to claim 18, wherein step c) retrieving the streamer comprises cleaning the streamer with mechanical and/or chemical means.

26. The method according to claim 19, wherein step c) retrieving the streamer comprises cleaning the streamer with mechanical and/or chemical means.

27. The method according to claim 21, wherein step c) retrieving the streamer comprises cleaning the streamer with mechanical and/or chemical means.
